(19) United States
(12) Patent Application Publication
(10) Pub. No.: US 2005/0152691 A1
(43) Pub. Date: Jul. 14, 2005

(54) Shutter apparatus

(75) Inventors: Takahiro Kawauchi, Fukushima-ken (JP); Akihito Yamamoto, Fukushima-ken (JP)

Correspondence Address: BRINKS HOFER GILSON & LIONE, P.O. BOX 10395, CHICAGO, IL, 60610, US

(73) Assignee: ALPS ELECTRIC CO., LTD.

(21) Appl. No.: 11/021,368

(22) Filed: Dec. 21, 2004

(30) Foreign Application Priority Data
Jan. 9, 2004 (JP) 2004-004737
Feb. 26, 2004 (JP) 2004-051484

(51) Int. Cl. G03B 9/08

(52) U.S. Cl. 396/463

(57) ABSTRACT

A shutter apparatus according to the present invention includes a base member having an opening with a predetermined diameter and first and second blades, which are placed on a blade support surface of the base member and can open and close the opening, wherein the first blade can open and close the opening by rotating on the blade support surface, and the second blade can open and close the opening by having a predetermined gap above the first blade so as to be arranged.

### BACKGROUND OF THE INVENTION

1. Field of the Invention

The present invention relates to shutter apparatuses, and in particular relates to a shutter apparatus for suitable use in digital movie cameras and digital still cameras.

2. Description of the Related Art

A conventional shutter apparatus will be described with reference to Japanese Unexamined Patent Application Publication No. 2002-345225. As shown in FIG. 6, a ring-shaped magnet 51 is provided with a fitting hole 51a formed in the center, an upward protruding dowel 51b, and two downward protruding dowels 51c and 51d.

The magnet 51 is divided into n equal parts in a circumferential direction so as to polarise to alternately have north and south magnetic poles.

On the magnet 51, a cylindrical coil 52 wound around an insulating bobbin 53 is arranged. The bobbin 53 is provided a dowel 53a formed to protrude.

On the coil 52, a disk-shaped yoke 54 made of a magnetic material is arranged so as to have comb-like first magnetic poles 54a, 54b, 54c, 54d, and 54e formed thereon. By turning on electricity to the coil 52, the first magnetic poles 54a, 54b, 54c, 54d, and 54e are excited so as to rotate the coil 52.

Under the magnet 51 having a fitting ring 56 fitted into the fitting hole 51a, a planer blade press-plate 59 is arranged that is a second magnetic pole excited by the coil 52 in opposite polarity to the first magnetic poles 54a to 54e.

In the center of the blade-press plate 59, an opening 59a is formed so as to have a predetermined diameter.

Under the blade press-plate 59, a base member 55 having a central opening 55a is arranged with first and second shutter blades 57 and 58 therebetween. The base member 55 is provided with dowels 55b and 55c and elongated holes 55d and 55e that can be brought into engagement with the dowels 51c and 51d of the magnet 51, respectively. By the rotation of the magnet 51, the dowels 51c and 51d abut the elongated holes 55d and 55e, respectively, so as to restrict the rotation angle of the magnet 51 at a predetermined angle.

A hole 57a of the first shutter blade 57 is fitted to the dowel 55c of the base member 55 while a hole 57b thereof is fitted to the dowel 51d of the magnet 51.

The second shutter blade 58 is provided with a hole 58a fitted to the dowel 55b of the base member 55 and a hole 58b fitted to the dowel 51c of the magnet 51. Under the base member 55, an ND filter (neutral density filter) 60 is rotatably arranged by the fitting of a hole 60a to a dowel (not shown) formed on the bottom surface of the base member 55.

The ND filter 60 is provided with a filter portion 60b having a small light transmittance bonded with an adhesive, etc.

By the rotation of the ND filter 60 about the hole 60a as a fulcrum, the filter portion 60b can cover the openings 55a and 59a of the base member 55 and the blade press-plate 59.

On a yoke 54, a link lever 61 is rotatably arranged about a hole 61a as a fulcrum, which is supported to the dowel 53a of the bobbin 53. Into a groove 61b of the link lever 61, the dowel 51b of the magnet 51 is fitted, so that when the magnet 51 rotates, the link lever 61 is rotated about the hole 61a as a fulcrum by an angle corresponding to the rotation of the magnet 51.

The link lever 61 is provided with a gear 61c mating with a gear 62a of an input gear 62.

The input gear 62 constitutes a one-way clutch together with an output member 63 having a ratchet gear (not shown) inside. A pin 63b of the output member 63 is slidably fitted into the elongated hole 60c of the ND filter 60.

The ND filter 60 is rotated corresponding to the rotation of the output member 63, so that the filter portion 60b covers or opens the openings 55a and 59a.

Upon describing the operation of the magnet 51 and the ND filter 60 in a conventional shutter apparatus structured in such a manner, during non-electrification to the coil 52, the filter portion 60b is retracted from the openings 55a and 59a so as to stop at a first exposure state.

When south poles of the first magnetic poles 54a to 54e of the yoke 54 are excited by electrically charging the coil 52 from this state, the magnet 51 having a magnetic force received in the rotating direction is clockwise rotated by a predetermined angle.

The input gear 62 is rotated via the link lever 61 at this time; however, the output member 63 does not rotate due to the function of the ratchet gear inside. Hence, the filter portion 60b of the ND filter 60 remains stopping in the first exposure state retracted from the opening 59a of the blade press-plate 59.

Then, when the electrification to the coil 52 is reversed in direction, north poles of the first magnetic poles 54a to 54e are excited so that the magnet 51 is counterclockwise rotated by a predetermined angle.

The input gear 62 is also rotated oppositely in operatively associated with the oppositely rotating magnet 51, so that the output member 63 is counterclockwise rotated by a predetermined angle by the function of the ratchet of the output member 63.

Following this, the ND filter 60 is rotated due to the pin 63b of the output member 63 so that the filter portion 60b covers the openings 55a and 59a.

Thereby, the amount of light passing through the openings 55a and 59a is reduced smaller than that in the first exposure state so as to become a second exposure state.

However, in the conventional shutter apparatus described above, the ND filter 60 has been rotated by the magnet 51 for rotating the first and second shutter blades 57 and 58 via the link lever 61, the input gear 62, and the output member 63, so that there has been a problem that the ND filter 60 rotates after a slight time lag behind the magnet 51, which is an actuator, due to accumulated backlashes produced between the members.

Also, the conventional shutter apparatus has required the link lever 61, the input gear 62, and the output member 63 having the ratchet gear inside, for operating the ND filter 60, so that a problem has arisen in that its cost increase due to increase in the number of components while its thickness increases.

During shutter operation in that the openings 55a and 59a are masked, the first and second shutter blades 57 and 58 may be retarded in rotational speed by the frictional force due to the sliding motion between them so as to lower a shutter speed.

When the magnet 51 is increased in size for increasing the shutter speed, there has been a problem in that the size of the conventional shutter apparatus is increased while electric power consumption increases.

### SUMMARY OF THE INVENTION

The present invention has been made for solving the problems described above, and it is an object of the present invention to provide a shutter apparatus capable of operating shutter blades and an ND filter with the small number of components, and also capable of reducing its thickness.

A shutter apparatus according to a first aspect of the present invention includes a base member comprising a base having an opening with a predetermined diameter; a first blade supported to a first blade support of the base member to be a shutter rotatable in directions opening and closing the opening; and a first link member which can rotate the first blade, wherein the base member comprises a first link support, which is disposed outside the base and can rotatably support the first link member; the first link member comprises a rotation support, which can be supported by the first link support; one end and the other end of the rotation support supported by the first link support are rotatable in seesaw motion; one surface of the first link member has a first magnet stuck thereon; the first magnet is excited to have one pole at one end thereof adjacent to the first link member and the other pole at the other end; a first coil is disposed so as to oppose the first magnet; and a magnetic flux produced by passing an electric current through the first coil acts on the magnetic flux of the first magnet, so that the first link member is rotated about the rotation support as a fulcrum in seesaw motion, and the first blade can open and close the opening.

A shutter apparatus according to a second aspect of the present invention includes a base member having an opening with a predetermined diameter; and first and second blades, which are placed on a blade support surface of the base member and can open and close the opening, wherein the first blade can open and close the opening by rotating on the blade support surface, and the second blade can open and close the opening by having a predetermined gap above the first blade so as to be arranged.

A shutter apparatus according to the present invention includes a first link member disposed outside a base member and a first coil disposed so as to oppose a first magnet stuck on the first link member, in which a magnetic flux produced by passing an electric current through the first coil acts on the magnetic flux of the first magnet, so that the first link member is rotated about a rotation support as a fulcrum in seesaw motion, and a shutter blade can open and close the opening, thereby providing a thin shutter apparatus.

Since a rotation support is formed at the link center of gravity of the first link member, even an impact is applied from outside, the first link member can be prevented from rotating.

Also, the first blade is formed in a thin plate shape and includes a support, which can be supported by a first blade (shutter) support of the base member, and an engagement portion, which can be brought into engagement with a first blade (shutter) actuator of the first link member, and when the rotation of the first link member is transmitted to the engagement portion via the first blade actuator, the shutter blade is rotated about the support as a fulcrum in a direction opposite to the rotational direction of the first link member, so that the shutter blade can be securely rotated with small rotational power of the first link member.

Since the shutter blade has a thin plate shape with small mass, even an impact is applied from outside, the shutter blade can be prevented from rotating.

Since the shutter actuator of the first link member is formed to have a projection shape, and the engagement portion of the shutter blade is formed to have an elliptic shape, when the first link member is rotated, the shutter actuator slides along the internal surface of the engagement portion so as to rotate the shutter blade about the support as a fulcrum in directions opening and closing the opening, enabling the shutter blade to be further securely rotated.

The base member includes a first link guide connecting between the external wall of the base and the periphery of the opening; the first link guide includes the first link support formed thereon; and the first link member is disposed inside the external wall of the base while the rotation support is supported by the first link support, so that the shutter blade can be rotated with the first link member disposed outside the base, thereby providing a shutter apparatus capable of reducing the thickness.

The base member includes a first blade support surface connecting between the external wall of the base and the periphery of the opening, and the shutter blade is supported to the first blade support formed on the first blade support surface, so that under the guidance of a blade guide, the shutter blade can be securely rotated about the shutter support as a fulcrum in directions opening and closing the opening.

The blade guide of the base member includes a protruded second blade (filter) support formed thereon; to the filter support, a second blade is rotatably supported, which is to be a filter having an ND filter attached thereto or to be a diaphragm having a small hole with a diameter smaller than that of the opening; and the amount of light passing through the opening is adjustable with the ND filter or the small hole, so that the diaphragm operation adjustable the amount of light passing through the opening can be securely performed with high accuracy.

Also, the base member includes a second link support, which can support the second link member; the second link member has a second magnet stuck thereon; and by passing an electric current through a second coil disposed to oppose the second magnet, the filter blade or the diaphragm blade is rotated, so that the amount of light passing through the opening can be securely adjusted by securely rotating the filter blade or the diaphragm blade.

The filter blade or the diaphragm blade is arranged to overlap the shutter blade thereon or thereunder; and the shutter blade and the filter blade or the diaphragm blade are independently rotatable by the rotation of the first and second link members, respectively, so that a shutter apparatus with excellent operability can be provided.

The first and second link members are placed on a circular yoke, and on the base member; a circular cover member is arranged with the shutter blade and the filter blade or the diaphragm blade therebetween, so that inside the circular portion, the shutter blade and the filter blade or the diaphragm blade can be arranged while magnets and coils capable of operating these blades can be efficiently arranged therein so as to provide a shutter apparatus small in size and thickness with a high degree of design freedom.

The cover member includes an elliptic hole formed at a position opposing the opening of the base member so that the ND filter can be rotatably positioned at the elliptic hole, so that the thickness of the ND filter can be absorbed with the elliptic hole, thereby further reducing the thickness of the apparatus.

The first and second coils are formed on an FPC (flexible printed circuit) arranged to oppose the first and second magnets with a predetermined gap therebetween, and the FPC is attached on the cover member, so that the assembling is easy.

In a shutter apparatus according to the present invention, the first blade can open and close the opening by rotating on the blade support surface, and the second blade can open and close the opening by having a predetermined gap above the first blade so as to be arranged, so that both the first and second blades can be rotated without rubbing against each other, producing no sliding friction.

The rotational speed of the first and second blades can be thereby increased so as to increase the shutter speed.

The blade support surface includes a pedestal, which can rotatably support the second blade, disposed outside the rotational range of the first blade so as to form the gap to the first blade with the pedestal, so that the second blade rotates on the pedestal, preventing the first and second blades from rubbing against each other.

The first blade is supported to a first blade support formed by the rotation fulcrum at the base member; the second blade is supported to a second blade support formed by the rotation fulcrum at the base member; and the masking portion is rotatably supported by the pedestal, so that the second blade can be securely prevented from rubbing against the first blade.

The second blade support can support the rotation fulcrum of the second blade at the same height as that of the pedestal, so that the second blade can be further securely prevented from rubbing against the first blade.

A portion of the second blade adjacent to the masking portion is supported by at least the first and second pedestals when the opening is opened; and the portion adjacent to the masking portion is supported by at least the second and third pedestals when the opening is masked, so that the second blade cannot be inclined when the opening is opened and masked.

The first blade is composed of a shutter blade which can mask the opening; the second blade is composed of a diaphragm blade having a filter adjustable the amount of light passing through the opening; and the second blade is provided with the filter arranged on a surface opposite to the surface opposing the first blade, so that the filter cannot rub against the first blade.

The thickness of the first blade is 50 μm, and the height of the pedestal is 100 μm, so that the gap between the first and second blades is to be about 50 μm, and the first and second blades cannot rub against each other.

### BRIEF DESCRIPTION OF THE DRAWINGS

FIG. 1 is an exploded perspective view of a shutter apparatus according to the present invention;

FIG. 2 is a plan view of an essential part of FIG. 1;

FIG. 3 is a side view of an essential part of FIG. 1;

FIG. 4 is a plan view illustrating the operation of a second blade according to the present invention;

FIG. 5 is a plan view illustrating the operation of the second blade according to the present invention; and

FIG. 6 is a plan view illustrating the operation of a conventional shutter apparatus.

### DESCRIPTION OF THE PREFERRED EMBODIMENTS

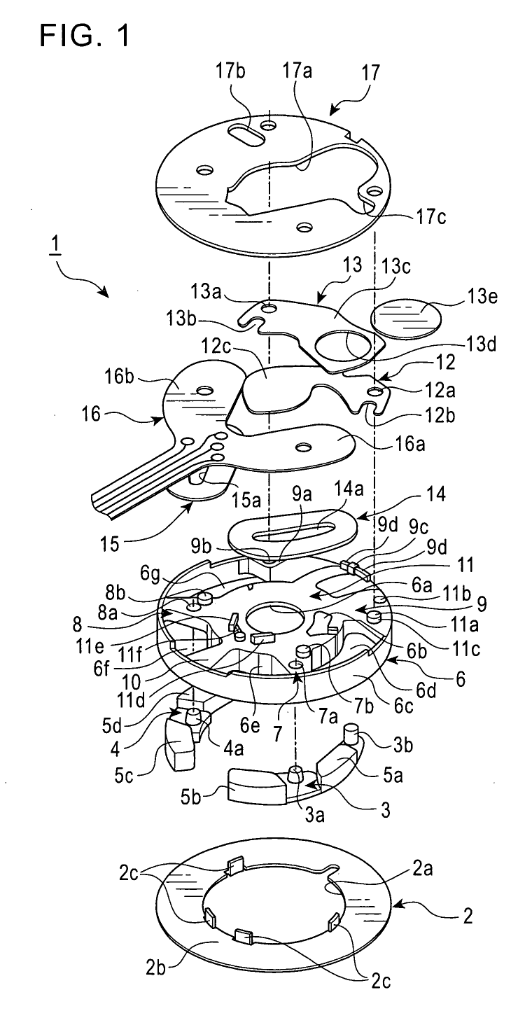

Embodiments of a shutter apparatus according to the present invention will be described below with reference to FIGS. 1 to 5.

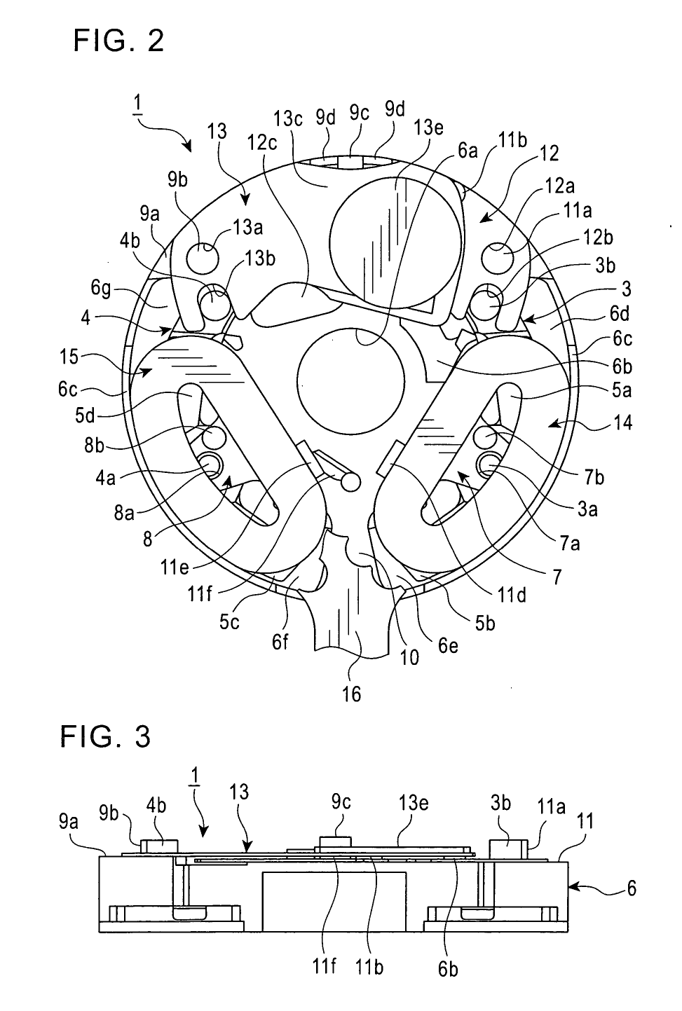

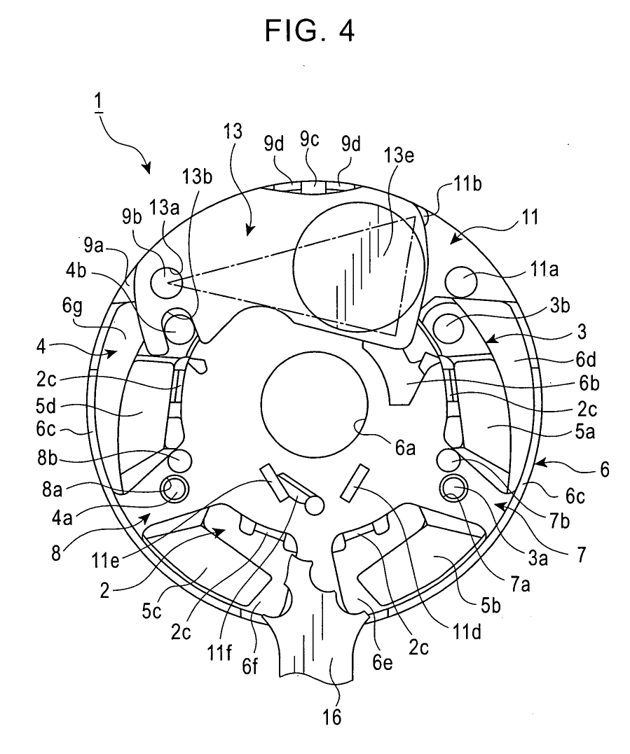

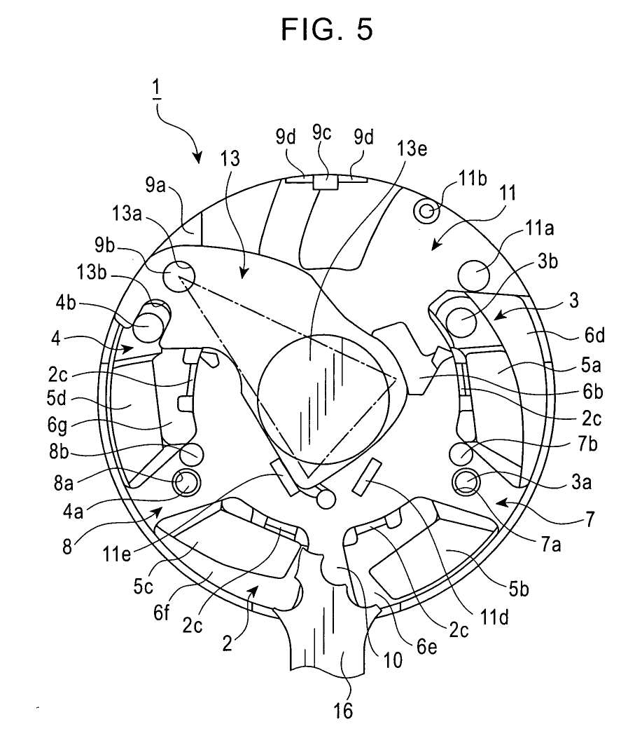

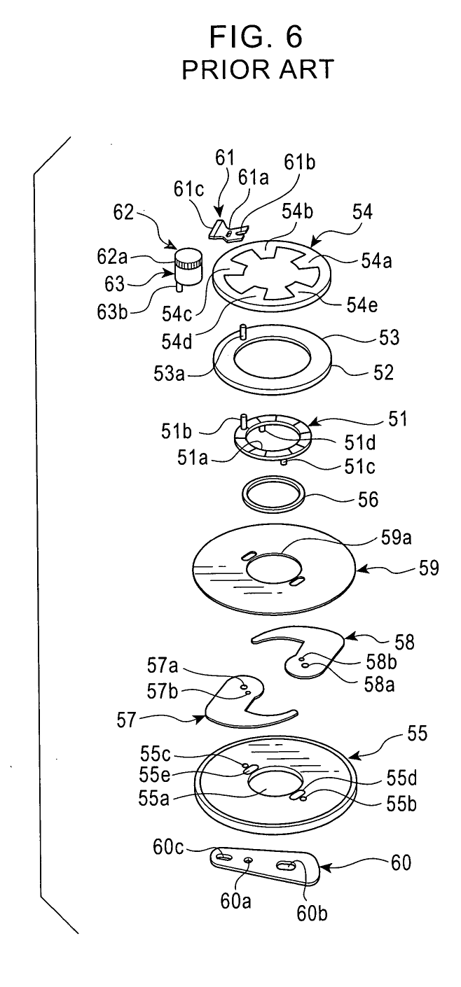

FIG. 1 is an exploded perspective view of the shutter apparatus according to the present invention; FIG. 2 is a plan view of an essential part of FIG. 1; FIG. 3 is a side view of an essential part of FIG. 1; and FIGS. 4 and 5 are plan views illustrating operation of a second blade according to the present invention.

First a shutter apparatus according to an embodiment of the present invention will be described with reference to FIGS. 1 to 4. In the lower most part, there is provided a circular yoke 2 with an external diameter of about 9 mm, which is made of a magnetic material such as a copper plate.

The yoke 2 is formed of a doughnut-shaped planar portion 2b having a central opening 2a which can be fitted to a circular base 6b of a base member 6, which will be described later. The yoke 2 also has four guide portions 2c made by cutting up the opening 2a, so that the base 6b of the base member 6 can be thereby guided for fitting into the opening 2a.

On the yoke 2, circular-arc first and second link members 3 and 4, which are symmetrical to each other, are placed. The first link member 3 is provided with a frusto-conical rotation support 3a protruded to have a predetermined height from the substantial center in longitudinal direction of the circular arc.

The first link member 3 is also provided with a columnar first blade (shutter) actuator 3b protruded to have a predetermined height from the back end of the drawing.

The second link member 4, which is symmetrical to the first link member 3, is provided with a frusto-conical rotation support 4a protruded from the substantial center in longitudinal direction of the circular arc and a columnar second blade (filter) actuator 4b protruded from the back end of the drawing.

On the upper surfaces of the first and second link members 3 and 4, a substantial circular-arc magnet 5 made of a permanent magnet is placed. The magnet 5 is composed of first and second magnets 5a and 5b, laterally bonded with an adhesive on the first link member 3 with the rotation support 3a therebetween, and third and fourth magnets 5c and 5d bonded on the second link member 4 with the rotation support 4a therebetween. The first to fourth magnets 5a to 5d are excited in parallel with the longitudinal direction of the first and second link members 3 and 4 to form magnetic poles at respective ends in the longitudinal direction.

The first magnet 5a on the first link member 3 is excited to form a north pole at the right end in the drawing and a south pole at the left end while the second magnet 5b is excited to form the north pole at the right end in the drawing and the south pole at the left end, for example.

Also, the third magnet 5c on the second link member 4 is excited to form the north pole at the near end in the drawing and the south pole at the back end while the fourth magnet 5d is excited to form the north pole at the near end in the drawing and the south pole at the back end.

On the yoke 2, the circular base member 6 made of a resin material is disposed with the first and second link members 3 and 4 therebetween. The base member 6 is provided with the substantial cylindrical base 6b having the opening 6a with a predetermined diameter formed at the center.

In the base member 6, the base 6b has an external diameter capable of fitting into the opening 2a of the yoke 2 while a peripheral wall 6c with a predetermined thickness is formed to have an internal diameter capable of fitting to the external diameter of the planar portion 2b of the yoke 2.

In the base member 6, the base 6b and the peripheral wall 6c are connected together with thin first and second link guides 7 and 8, and first and second connection portions 9 and 10, which are thicker than the first and second link guides 7 and 8, therebetween.

Between the first link guide 7 and the first connection portion 9, a first open portion 6d is formed; between the first link guide 7 and the second connection portion 10, a second open portion 6e is formed; between the second link guide 8 and the second connection portion 10, a third open portion 6f is formed; and between the second link guide 8 and the first connection portion 9, a fourth open portion 6g is formed.

The first link guide 7 is provided with a support hole 7a, which can be fitted to the rotation support 3a of the first link member 3, and a convex portion 7b protruded in the vicinity of the support hole 7a to have a predetermined height.

In the first link member 3 supporting the first link guide 7 by fitting the rotation support 3a into the support hole 7a, the first magnet 5a is located in the first open portion 6d while the second magnet 5b is located in the second open portion 6e.

Between the base 6b and the peripheral wall 6c, the first link member 3 is rotatable about the rotation support 3a as a fulcrum.

the second link guide 8 is provided with a support hole 8a, which can be fitted to the rotation support 4a of the second link member 4, and a convex portion 8b protruded in the vicinity of the support hole 8a.

In the second link member 4 supporting the second link guide 8 by fitting the rotation support 4a into the support hole 8a, the third magnet 5c is located in the third open portion 6f while the fourth magnet 5d is located in the fourth open portion 6g.

Between the base member 6 and the peripheral wall 6c, the second link member 4 is rotatable about the rotation support 4a as a fulcrum.

On the surfaces of the base 6b and the first connection portion 9, a first blade-support surface 11 with a large area is flatly arranged, on which a first blade 12, which is a shutter blade and will be described later, is rotatably positioned.

On the first blade-support surface 11 and in the vicinity of the first open portion 6d, a first blade support 11a is protruded, which can rotatably support the first blade 12, so as to have predetermined diameter and height.

In the vicinity of the fourth open portion 6g of the first connection portion 9, a second blade-support surface 9a is arranged so as to have a height higher than that of the first blade-support surface 11 by about 100 μm, on which a second blade 13 is rotatably positioned, which will be described later.

On the second blade-support surface 9a, a second blade support 9b is protruded, which can rotatably support the second blade 13, so as to have predetermined diameter and height.

The first connection portion 9 is provided with a first projection 9c formed in the external periphery so as to have substantially the same thickness as that of the peripheral wall 6c and a height higher than that of the peripheral wall 6c and second projections 9d formed laterally adjacent to the first projection 9c on both sides so as to have a height lower than that of the first projection 9c.

Between the first blade support 11a and the first projection 9c, a first pedestal 11b is formed at a position close to the external periphery of the first blade-support surface 11 so as to have a height higher than that of the first blade-support surface 11 by about 100 μm (the same height as that of the second blade-support surface 9a).

The first blade-support surface 11 on the base 6b between the opening 6a and the first open portion 6d is provided with a substantially rectangular second pedestal 11c formed thereon so as to have the same height as that of the first pedestal 11b.

On the first blade-support surface 11 between the second open portion 6e and the opening 6a, a first coil-support wall 11d is formed; on the first blade-support surface 11 between the third open portion 6f and the opening 6a, a second coil-support wall 11e is formed; and a third pedestal 11f is formed in contact with the second coil-support wall 11e at a position close to the opening 6a so as to have the same height as those of the first and second pedestals 11b and 11c.

A portion of the third pedestal 11f adjacent to the opening 6a is tapered so that the second blade 13 is easily positioned on the third pedestal 11f during rotation.

The second blade-support surface 9a and the first to third pedestals 11b to 11f are respectively disposed outside the rotational range of the first blade 12 rotating on the first blade-support surface 11 so as not to disturb the rotation of the first blade 12 during the shutter operation masking the opening 6a.

A circular-hole rotation support 12a of the first blade 12 is fitted to the first blade support 11a formed on the first blade-support surface 11 of the base member 6.

The first blade 12 is made of a resin material having kneaded conduction powder, such as carbon, and has a thickness of about 50 μm.

The first blade 12 is also provided with a U-shaped engagement groove 12b, which can fit the first blade actuator 3b of the first link member 3, formed in the near side of the rotation support 12a in the drawing.

At a position separated from the rotation support 12a by a predetermined distance to the left in the drawing, a masking portion 12c with a large area is formed, which can open and close the opening 6a of the base member 6.

A circular-hole rotation fulcrum 13a of the second blade 13, which is a diaphragm blade, is fitted to the second blade support 9b formed on the second blade-support surface 9a. The second blade 13 is made of a resin material having kneaded carbon, and has a thickness of about 50 μm, in the same way as in the first blade 12.

The second blade 13 is provided with a U-shaped engagement groove 13b, which can fit the second blade actuator 4b of the second link member 4, formed in the near side of a rotation fulcrum 13a in the drawing.

At a position of the second blade 13 separated from the rotation fulcrum 13a by a predetermined distance to the right in the drawing, a masking portion 13c is formed, which includes an opening 13d formed with a diameter slightly greater than that of the opening 6a of the base member 6. On the opening 13d, an ND filter 13e with a predetermined thickness is bonded with an adhesive so that the amount of light passing through the opening 6a can be adjusted.

In the second blade 13 in a state of opening the opening 6a, as shown in FIG. 4, while a portion adjacent to the rotation fulcrum 13a is located on the second blade-support surface 9a, a portion adjacent to the masking portion 13c is supported to the first and second pedestals 11b and 11c, and three corners of the substantial triangle shown by a dashed-and-dotted line are supported at a height of about 100 μm from the first blade-support surface 11.

That is, there is a gap of about 50 μm between the first blade 12 supported on the first blade-support surface 11 and the second blade 13 supported by the second blade-support surface 9a and the first and second pedestals 11b and 11c.

A first coil 14, wound in a thin-plate and substantial elliptical shape, is arranged on the first and second magnets 5a and 5b attached to the first link member 3 and located in the first and second open portions 6d and 6e. The first coil 14 is placed on the base member 6 by guiding the external periphery adjacent to the opening 6a with the first coil-support wall 11d while guiding the circular-arc periphery with the internal surface of the peripheral wall 6c.

A second coil 15 with the same shape as that of the first coil 14 is also arranged on the third and fourth magnets 5c and 5d attached to the second link member 4 and located in the third and fourth open portions 6f and 6g.

The second coil 15 is placed on the base member 6 by guiding the external periphery adjacent to the opening 6a with the second coil-support wall 11e while guiding the circular-arc periphery with the internal surface of the peripheral wall 6c.

For the first and second coils 14 and 15, a pair of coil supports 16a and 16b are bonded to a forked FPC (flexible printed circuit board) 16 with an adhesive.

On the FPC 16 and the second blade 13, a cover member 17 made of a magnetic material such as a tinned steel plate is arranged.

The cover member 17 is provided with a first elliptic hole 17a formed at a position opposing the opening 6a of the base member 6. At the first elliptic hole 17a, the ND filter 13e is located rotatably in the direction of the second blade 13 opening and closing the opening 6a.

On both sides of the first elliptic hole 17a laterally in the drawing and in a direction perpendicular to the first elliptic hole 17a, a second elliptic hole 17b with a size smaller than the first elliptic hole 17a and a U-shaped groove 17c are formed. While the first blade actuator 3b of the first link member 3 is brought into engagement with the U-shaped groove 17c, the second blade actuator 4b of the second link member 4 is brought into engagement with the second elliptic hole 17b.

Upon assembling the shutter apparatus 1 according to the present invention structured in such a manner, on the planar portion 2b of the yoke 2, the first link member 3 having the first and second magnets 5a and 5b bonded thereto is placed while the second link member 4 having the third and fourth magnets 5c and 5d bonded thereto is placed.

Then, the base member 6 is placed on the first and second link members 3 and 4 so as to fit the rotation support 3a of the first link member 3 into the support hole 7a of the first link guide 7 as well as to fit the rotation support 4a of the second link member 4 into the support hole 8a of the second link guide 8.

When the first and second magnets 5a and 5b are located in the first and second open portions 6d and 6e, respectively, while the third and fourth magnets 5c and 5d are located in the third and fourth open portions 6f and 6e, respectively, the first and second link members 3 and 4 are rotated about the rotation supports 3a and 4a as fulcrums, respectively, so as to have seesaw motion.

The respective blade actuators 3b and 4b of the first and second link members 3 and 4 are protruded upper than the first blade-support surface 11.

Next, the rotation support 12a of the first blade 12 is fitted to the first blade support 11a of the base member 6 while the first blade actuator 3b of the first link member 3 is brought into engagement with the engagement groove 12b.

Also, the second blade 13 having the ND filter 13e attached thereto is placed on the first blade 12 so as to fit the rotation fulcrum 13a to the second blade support 9b of the base member 6 while the second blade actuator 4b of the second link member 4 is brought into engagement with the engagement groove 13b.

Then, a portion adjacent to the rotation fulcrum 13a of the second blade 13 is located on the second blade-support surface 9a while a portion adjacent to the masking portion 13c is supported to the first and second pedestals 11b and 11c. The second blade 13 is thereby placed on the first blade 12 with a gap of about 50 μm therebetween.

Next, the first coil 14 having the FPC 16 attached thereto is guided with internal surfaces of the first coil-support wall 11d and the peripheral wall 6c while the second coil 15 is guided with internal surfaces of the second coil-support wall 11e and the peripheral wall 6c, so that the first and second coils 14 and 15 are placed on the base member 6.

Then, when the FPC 16 and the second blade 13 are covered with the cover member 17 thereon, the ND filter 13e is positioned at the first elliptic hole 17a while the second blade support 9b is positioned at the second elliptic hole 17b. Simultaneously, the first blade support 11a is positioned at the U-shaped groove 17c.

Finally, by bonding the cover member 17 to the peripheral wall 6c of the base member 6 with an adhesive as well as by sticking the guide portions 2c made by cutting up the yoke 2 to the base member 6, the shutter apparatus 1 according to the present invention is assembled.

The shutter apparatus 1 assembled in such a manner has a low profile such that the outer diameter is 9 mm and the thickness between the yoke 2 and the cover member 17 is 1.5 mm.

In the operation of the shutter apparatus 1 assembled in such a manner, for example, the magnetic flux produced by passing a current through the first coil 14 acts on the magnetic flux of the first and second magnets 5a and 5b so as to clockwise rotate the first link member 3 in the drawing about the rotation support 3a as a fulcrum in a direction that the first blade actuator 3b is separated from the base 6b of the base member 6.

Along with this, the engagement groove 12b is operated by the first blade actuator 3b so as to counterclockwise rotate the first blade 12 about the rotation support 12a as a fulcrum.

The masking portion 12c is thereby rotated in a direction closing the opening 6a so as to perfectly close the opening 6a.

If the electrification to the first coil 14 is reversed, the first link member 3 is counterclockwise rotated in a direction that the first blade actuator 3b approaches the base 6b of the base member 6. The first blade 12 is thereby rotated clockwise about the rotation support 12a as a fulcrum so as to open the opening 6a.

Since the first blade 12 during the shutter operation masking/opening the opening 6a in such a manner has a gap of about 50 μm, rapid shutter operation can be performed without rubbing to the second blade 13.

By passing an electric current through the second coil 15, the second link member 4 is clockwise/counterclockwise rotated about the rotation support 4a as a fulcrum so as to rotate the second blade 13.

By the rotation of the second blade 13, the ND filter 13e masks the opening 6a so as to adjust the amount of light passing through the opening 6a as diaphragm operation.

In the second blade 13 in a state that the ND filter 13e opens the opening 6a, as shown in FIG. 4, a portion adjacent to the masking portion 13c is supported by the first and second pedestals 11b and 11c, and three corners of the triangle shown by a dashed-and-dotted line are supported.

In the second blade 13 during the diaphragm operation in that the ND filter 13e masks the opening 6a, as shown in FIG. 5, a portion adjacent to the masking portion 13c is supported to the second and third pedestals 11c and 11f, and the three corners of the triangle shown by the dashed-and-dotted line are supported.

Hence, even if the weight of the ND filter 13e is added, the second blade 13 can smoothly perform the diaphragm operation without rubbing to the first blade 12.

According to the embodiment of the present invention, the support of the second blade 13 to the ND filter 13e has been described with the three first to third pedestals 11b to 11c; however, they may also be four or more pedestals formed on the first blade-support surface 11 outside the rotational range of the first blade 12.

That is, the pedestals may be at least three first to third pedestals 11b to 11f.

A portion of the second blade 13 during opening the opening 6a adjacent to the masking portion 13c is supported to at least three places of the second blade-support surface 9a and the first and second pedestals 11b and 11c, while the masking portion 13c during masking the opening 6a is supported to at least two places of the second blade-support surface 9a and the second and third pedestals 11c and 11f.

Thus, the first blade 12 is horizontally supported and cannot be in friction to the second blade 13 during opening/masking the opening 6a.

According to the embodiment of the present invention, the second blade 13 is described with a diaphragm blade having the ND filter 13e; alternatively, the second blade 13 may be a shutter blade like the first blade 12.

That is, by first blades 12 and 12 composed of two shutter blades, the opening 6a may be masked.

1. A shutter apparatus comprising:
a base member comprising a base having an opening with a predetermined diameter;
a first blade supported by a first blade support of the base member to be a shutter rotatable in directions opening and closing the opening; and
a first link member which rotates the first blade,
wherein the base member comprises a first link support, which is disposed outside the base and rotatably supports the first link member;
the first link member comprises a rotation support, which is supported by the first link support;
one end and the an opposing end of the rotation support supported by the first link support are rotatable in seesaw motion;
one surface of the first link member has a first magnet stuck thereon;
the first magnet is excited to have one pole at one end thereof adjacent to the first link member and an opposing pole at the other end;
a first coil is disposed so as to oppose the first magnet; and
a magnetic flux produced by passing an electric current through the first coil acts on a magnetic flux of the first magnet, so that the first link member is rotated about the rotation support as a fulcrum in seesaw motion, and the first blade opens and closes the opening.

2. The apparatus according to claim 1, wherein the first link member comprises a first blade actuator for rotating the first blade;
the first blade is formed in a thin plate shape and comprises a support, which is supported by the first blade support of the base member, and an engagement portion, which is brought into engagement with the first blade actuator of the first link member; and
when the rotation of the first link member is transmitted to the engagement portion via the first blade actuator, the first blade is rotated about the support as a fulcrum in a direction opposite to the rotational direction of the first link member.

3. The apparatus according to claim 2, wherein the first blade actuator of the first link member is formed to have a projection shape;
the engagement portion of the first blade is formed to have an elliptic shape; and
when the first link member is rotated, the first blade actuator slides along an internal surface of the engagement portion so as to rotate the first blade about the support as a fulcrum in directions opening and closing the opening.

4. The apparatus according to claim 1, wherein the base member comprises a first link guide connecting between an external wall of the base and a periphery of the opening;
the first link guide comprises the first link support formed thereon; and
the first link member is disposed inside the external wall of the base while the rotation support is supported by the first link support.

5. The apparatus according to claim 1, wherein the base member comprises a first blade support surface connecting between an external wall of the base and ha periphery of the opening; and
the first blade is supported by the first blade support formed on the first blade support surface.

6. The apparatus according to claim 5, wherein the first blade support surface of the base member comprises a protruded second blade support formed thereon;
a second blade is rotatably supported by the second blade support which is a filter having an ND filter attached thereto or a diaphragm having a small hole with a diameter smaller than that of the opening; and
an amount of light passing through the opening is adjustable with the ND filter or the small hole.

7. The apparatus according to claim 6, further comprising a second link member, which is symmetric with the first link member in shape, disposed in an external periphery of the base of the base member and opposing the first link member,
wherein the base member comprises a second link support, which supports the second link member;
the second link member has a second magnet stuck thereon; and
by passing an electric current through a second coil disposed to oppose the second magnet, the second blade is rotated.

8. The apparatus according to claim 7, wherein the second blade is arranged to overlap the first blade thereon or thereunder; and
the first blade and the second blade are independently rotatable by the rotation of the first and second link members, respectively.

9. The apparatus according to claim 8, wherein the first and second link members are placed on a circular yoke, and on the base member, a circular cover member is arranged with the first blade and the second blade therebetween.

10. The apparatus according to claim 9, wherein the cover member comprises an elliptic hole formed at a position opposing the opening of the base member so that the ND filter is rotatably positioned at the elliptic hole.

11. The apparatus according to claim 7, wherein the first and second coils are formed on an FPC (flexible printed circuit) arranged to oppose the first and second magnets with a predetermined gap therebetween, and the FPC is attached on a cover member.

12. A shutter apparatus comprising:
a base member having an opening with a predetermined diameter; and
first and second blades, which are placed on a blade support surface of the base member and opens and closes the opening,
wherein the first blade opens and closes the opening by rotating on the blade support surface, and the second blade opens and closes the opening by having a predetermined gap above the first blade so as to be arranged.

13. The apparatus according to claim 12, wherein the blade support surface comprises a pedestal, which rotatably supports the second blade, disposed outside a rotational range of the first blade so as to form the gap to the first blade with the pedestal.

14. The apparatus according to claim 13, wherein the first and second blades comprise a rotation fulcrum, which is rotatably supported by the base member, and a masking portion disposed at a position separated from the rotation fulcrum for masking the opening; the first blade is supported by a first blade support formed by the rotation fulcrum at the base member; the second blade is supported by a second blade support formed by the rotation fulcrum at the base member; and the masking portion is rotatably supported by the pedestal.

15. The apparatus according to claim 14, wherein the second blade support supports the rotation fulcrum of the second blade at the same height as that of the pedestal.

16. The apparatus according to claim 14, wherein the pedestal comprises at least first to third pedestals protruded from the blade support surface at a predetermined height;
a portion of the second blade adjacent to the masking portion is supported by at least the first and second pedestals when the opening is opened; and
the portion of the second blade adjacent to the masking portion is supported by at least the second and third pedestals when the opening is masked.

17. The apparatus according to claim 12, wherein the first blade is composed of a shutter blade which masks the opening;
the second blade is composed of a diaphragm blade having a filter that adjusts an amount of light passing through the opening; and
the second blade is provided with the filter arranged on a surface opposite to a surface opposing the first blade.

18. The apparatus according to claim 13, wherein a thickness of the first blade is 50 μm, and a height of the pedestal is 100 μm.
